(19) United States
(12) Patent Application Publication
(10) Pub. No.: US 2002/0118868 A1
(43) Pub. Date: Aug. 29, 2002

(54) Method and apparatus for correcting differential image detecting shape change

(76) Inventor: Toshifumi Okada, Amagasaki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/960,475

(22) Filed: Sep. 24, 2001

(30) Foreign Application Priority Data
Dec. 22, 2000 (JP) 2000-389974

(51) Int. Cl. H04N 5/14; H04N 9/64; G06K 9/00

(52) U.S. Cl. 382/130; 382/203

(57) ABSTRACT

A differential image for detecting a shape change between one input image and another input image is corrected by setting reference areas which are deemed to have no shape change to the one and another input images In1(x,y) and In2(x,y), respectively, operating average values ave1 and ave2 of pixel values of the reference areas in a reference area average value operating unit, and producing a differential image S(x,y) in accordance with an equation of S(x,y)=In1(x,y)−In2(x,y)−(ave1−ave2) in a differential image producing unit. Such differential image is displayed with an offset value being applied.

### BACKGROUND OF THE INVENTION

The present invention relates to a method and apparatus for correcting differential image which is utilized for detecting shape change, for example, which is applicable to a system for detecting interval changes in chest region (thoracic part) images continuous in time, in a computer analysis technology of a digital medical image such as a chest radiograph. The present invention will be further applicable to a system for detecting shape change in two images in a general image processing field.

In a prior art of image processing system, in order to investigate change of two images, there has usually been utilized a differential image obtained from differential value for every pixel of both the images.

In the conventional method, mentioned above, of obtaining a general differential image, in a certain case, there causes that pixel values of two images are different from each other due to, for example, difference in photographing, i.e. imaging, condition to a portion in which no shape change occurs (a portion at which “0” differential value is expected). In such images, a differential value is outputted for the portion having no shape change, and for this reason, the appearance of the differential image differs for every output image and the appearance of an area of the no shape change may be different, providing an inconvenience.

### SUMMARY OF THE INVENTION

An object of the present invention is to substantially eliminate defects or drawbacks encountered in the prior art mentioned above and to provide method and apparatus for correcting differential image for detecting shape change, which is capable of keeping constant an appearance of output differential images by making constant differential values in an area of no shape change.

This and other objects can be achieved according to the present invention by providing, in one aspect, a method of correcting a differential image for detecting a shape change between one input image and another input image comprising the steps of:

setting reference areas which are deemed to have no shape change to the one and another input images In1(x,y) and In2(x,y), respectively;

operating average values ave1 and ave2 of pixel values of the reference areas; and

producing a differential image S(x,y) in accordance with an equation of

S(x,y)=In1(x,y)−In2(x,y)−(ave1−ave2).

In a preferred embodiment of this aspect, an offset value is applied at the differential image producing step, and the differential image S(x,y) may be displayed for observation.

In the other aspect of the present invention, there is provided an apparatus for correcting a differential image detecting shape change, comprising:

an image data storing means for storing image data;

a reference area setting means for setting reference areas which are deemed to have no shape change to one and another input images, respectively;

a reading means for reading the image data from the image data storing means and the reference area data from the reference area setting means;

an average value operating means for calculating average values of pixel values of the reference areas of the input images, respectively; and

a differential image producing means for producing a differential image on the basis of the average values calculated in the average value operating means.

In a preferred embodiment of this aspect, the apparatus further comprises an offset value setting means for applying an offset value to the differential image producing means, and may further comprises a display means for displaying the differential image.

According to these aspects of the present invention, since the differential image S(x,y) is produced by calculating the average values of the pixel values of the reference areas in accordance with the equation of S(x,y)=In1(x,y)−In2(x,y)−(ave1−ave2), a differential image data in which the pixel value at the no shape change portion between one and another input images can be obtained, so that the appearance of the input differential image can be kept constant.

Furthermore, in the case where the offset value is applied at the time of displaying the differential image, for example, when (gray level)/2 is set as such offset value, it becomes possible to obtain an image with a half of the gray level being a reference, and accordingly, a variation of the differential image can be visually observed. Moreover, even if black and white colors are inverted, the pixel value as reference is not changed, thus being convenient.

The nature and further characteristic features will be made more clear from the following descriptions made with reference to the accompanying drawings.

### BRIEF DESCRIPTION OF THE DRAWINGS

In the accompanying drawings:

FIG. 1 is a diagram showing a production apparatus for differential images detecting a shape change according to one embodiment of the present invention;

FIG. 2 is a flowchart of the production of the differential image by using the production apparatus of FIG. 1;

FIG. 3 shows examples of an input image;

FIG. 4 shows examples setting a reference area with respect to the input images 1 and 2;

FIG. 5 shows other examples setting a reference area with respect to the input images 1 and 2;

FIG. 6 is a photograph showing the actual input image 1;

FIG. 7 is a photograph showing the actual input image 2;

FIG. 8 is a photograph showing a differential image between the input images 1 and 2 in the case of no application of the present invention;

FIG. 9 is a photograph showing a differential image between the input images 1 and 2 in the case of application of the present invention;

FIG. 10 is a photograph showing another differential image in the case of no application of the present invention;

FIG. 11 is a photograph of a differential image in a case where the present invention is applied to the same input image as in FIG. 10;

FIG. 12 is a photograph showing a further differential image in the case of no application of the present invention;

FIG. 13 is a photograph of a differential image in a case where the present invention is applied to the same input image as in FIG. 12;

FIG. 14 is a photograph showing a still further differential image in the case of no application of the present invention; and

FIG. 15 is a photograph of a differential image in a case where the present invention is applied to the same input image as in FIG. 14.

### DESCRIPTION OF THE PREFERRED EMBODIMENTS

The present invention will be described in detail hereunder with reference to the accompanying drawings.

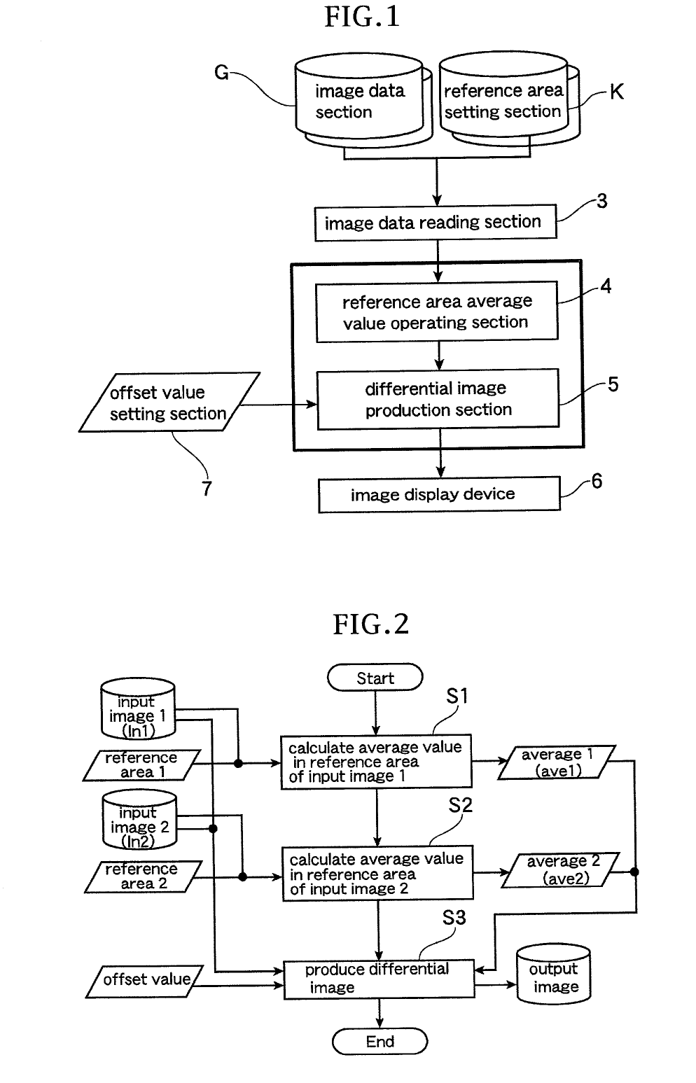

With reference to FIG. 1 showing a diagram of a structure of a production apparatus for differential images for detecting a shape change according to one embodiment of the present invention, reference character G denotes an image data section for storing image data and character K denotes a reference area (region) setting section. Data from the image data section G and data from the reference area setting section K is sequentially treated by an image reading section 3, a reference area average value operating section 4, a differential image production section 5 and an image display section 6. In these sections, the reference area average value operating section 4 and the differential image production section 5, which are surrounded by a thick solid line, constitute an essential part of the present invention. Further, although an offset value setting section 7 is additionally disposed, this is not essential.

The differential image production apparatus of the structure mentioned above will operate in accordance with the flowchart of FIG. 2 in the following manner.

In a step S1, an input image In1(x,y) from the input data section G and a reference area data from the reference area K are inputted in and read by the image data reading section 3, and the reference area average value operating section 4 operates a reference area average value as average value ave1.

In a step S2, an input image In2(x,y) from the input data section G and a reference area data from the reference area K are inputted in and read by the image data reading section 3, and the reference area average value operating section 4 operates a reference area average value as average value ave2.

In a step S3, the image data of the input image In1(x,y) and the image data of the input image In2(x,y) and the ave1 and ave2 obtained in the reference area average value operating section 4 are given (inputted) to the differential image production section 5, in which a differential image S(x,y) is produced according to such inputted values.

The setting of the reference area in the above steps S1 and S2 is a setting of an area in which a shape of the image is deemed to be not changed between the input image In1(x,y) and the input image In2(x,y). The obtained data is kept in a structure of the reference area K and such reference area is set to each of the input image In1(x,y) and the input image In2(x,y).

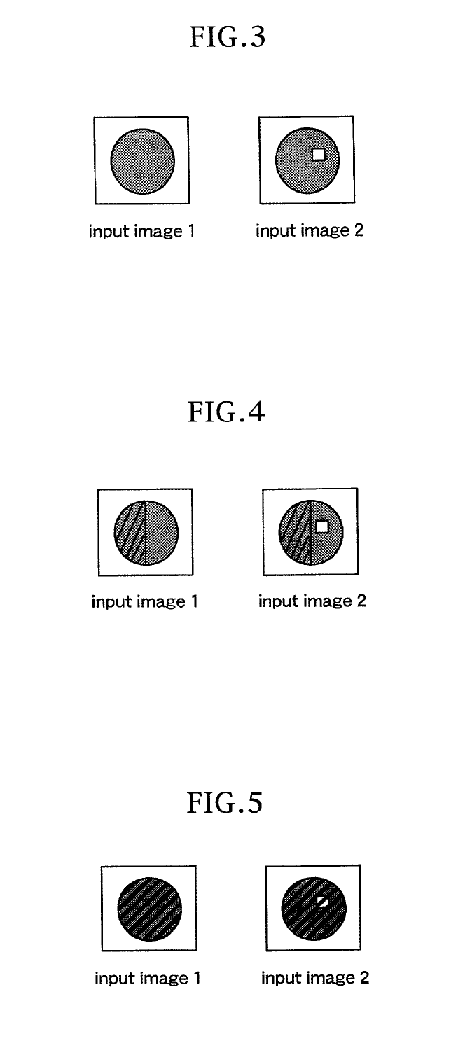

For example, in a case of the input images 1 and 2 being ones shown in FIG. 3, the reference areas shown with oblique lines in FIG. 4 are set for investigating the shape change of circular areas of FIG. 3.

In a case where the area in which the shape change occurs is sufficiently smaller than the area in which the shape change does not occur, the area in which the shape change occur may be included in the area in which the shape change does not occur as shown in FIG. 5. In such case, although a differential value in an area in which the shape change does not occur to every differential image S(x,y) is different, on a visual appearance, effects or functions substantially identical to those shown in FIG. 4 will be obtained. Further, the degree of setting the reference area will be determined on the basis of an actual usage of the output image.

The operation of the differential image (input image 1-input image 2) in the step S3 by the differential image production section 5 will be performed in accordance with the following equation.

S(x,y)=In1(x,y)−In2(x,y)−(ave1−ave2)

According to the processing on the basis of this equation, a differential image data, in which the pixel value in a no change area between the input image 1 and the input image 2 is zero “0”, can be obtained.

In an arrangement provided with the offset value setting section 7, offset values (offset) will be added to respective pixel values of the differential images so as to easily observe the differential image on the image display section 6 such as CRT (cathode ray tube). That is, the output image 0(x,y) is obtained as 0(x,y)=S(x,y)+offset, which is then displayed.

In the case where the offset value is not added, the output value obtained is an image having positive and negative values with no change area being “0”, and for example, if gray level/2 is set, an image having a half of the gray level as a reference will be obtained.

In the case where the offset value is not set, the amount of change of the image can be advantageously utilized as the pixel value itself. Further, when an offset value of gray level/2 is added, the amount of change can be observed more visually. Furthermore, even if white and black colors of the image are inverted, the pixel value as the reference does not change, thus being also advantageous.

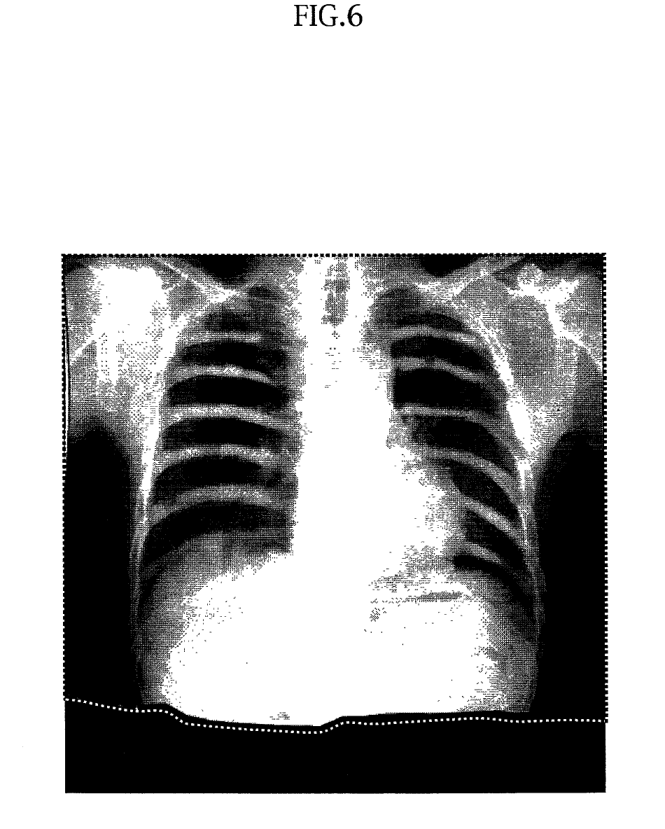

FIGS. 6 to 9 represent examples of chest radiographs continuous in time obtained by a system detecting interval change to which the present invention is applied.

This system aims to detect the interval change between two sheets of chest radiographs. Images inputted into the system are subjected to respective treatments of rotation, movement, transformation and the like. During such treatments, there occurs an area in which the pixel data of the input image is lost. In this application of the present invention, an area in which the input image area exists is set as the reference area.

FIG. 6 is a photograph representing the input image 1 used for the differential treatment (processing), and the reference area is surrounded by a frame of dotted lines.

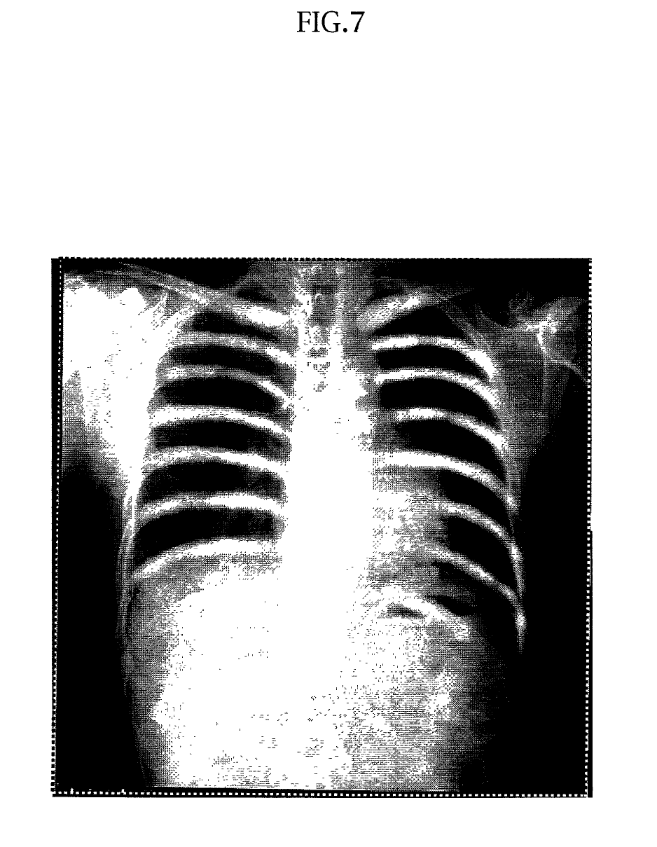

FIG. 7 is also a photograph representing the input image 2 used for the differential treatment (processing), and the reference area is surrounded by a frame of dotted lines as like as FIG. 6.

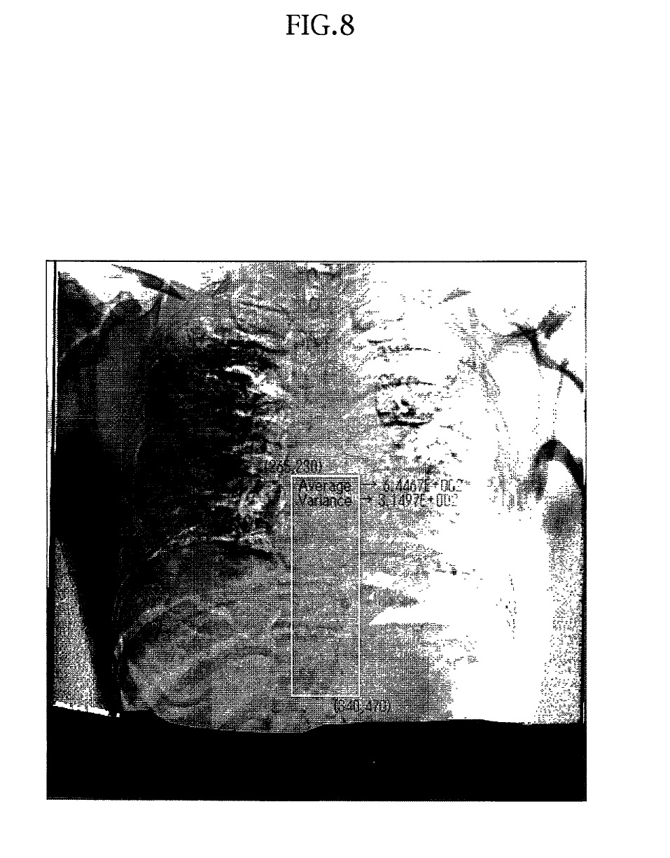

FIG. 8 also shows a photograph representing a differential image in a case to which the present invention is not applied. In this case, the average values of ave1 and ave2 are calculated throughout the entire areas of the input images 1 and 2, and an offset value of 511 is designated. Furthermore, an average value in the frame of solid lines set as an area having less shape change is 556.

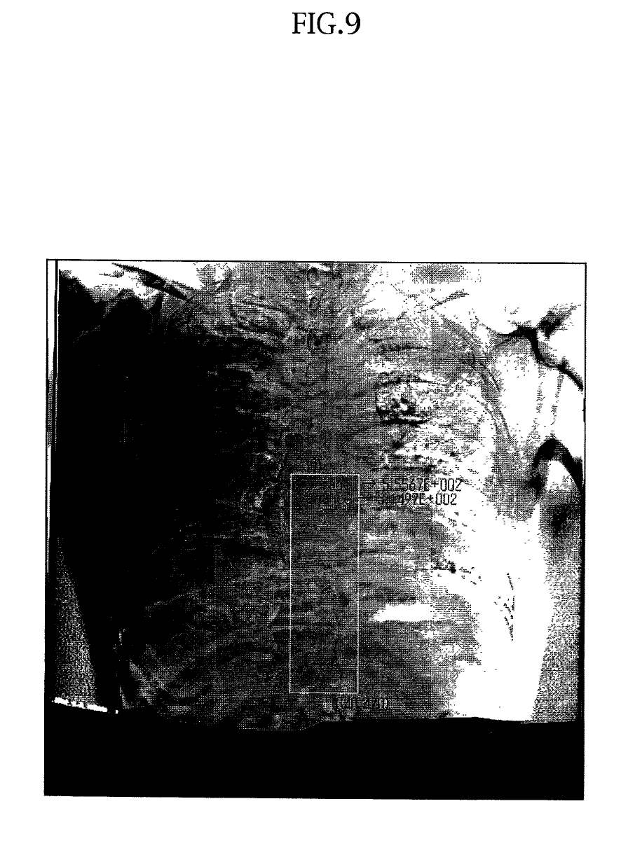

In the application example mentioned above, it is expected for the output representing the portion having no shape change to provide the pixel value of near 511. As described with reference to FIG. 9, by the application of the present invention, such expected effects have been achieved.

The obtained results are shown in the following Table 1.

TABLE 1

| | Average in Solid | Difference from |
|---|---|---|
| | Line Frame | Expected Value |
| Application A | 645 | +134 |
| Application B | 556 | +45 |

* Application A is an example to which the present invention is not applied as represented by FIG. 8, and Application B is an example to which the present invention is applied as represented by FIG. 9.

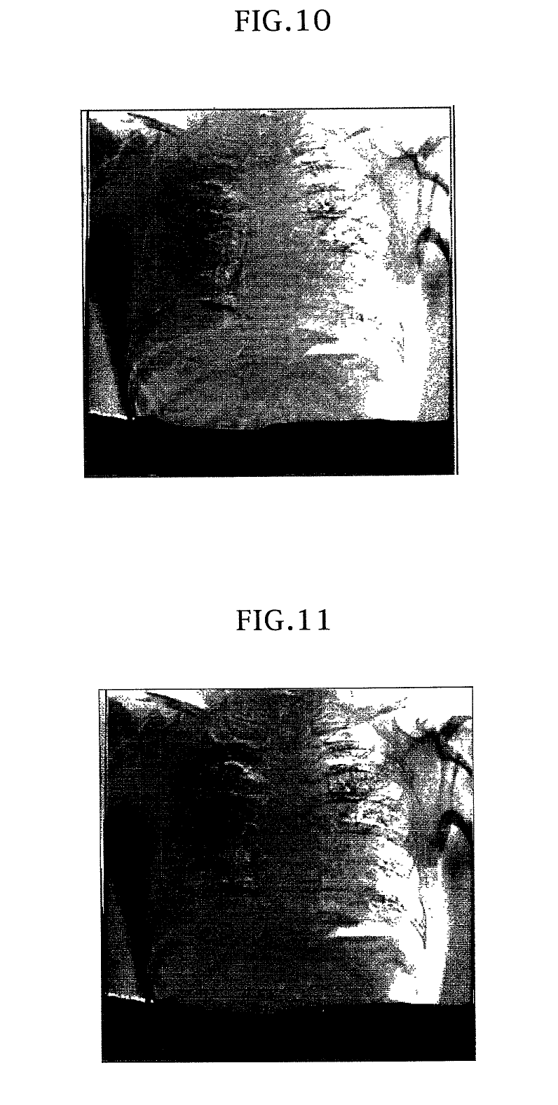

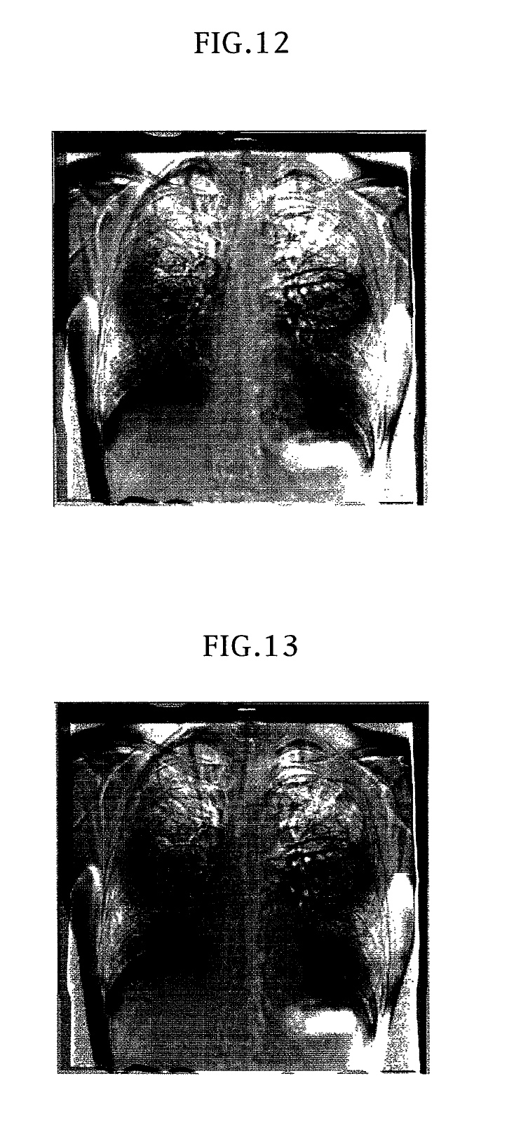

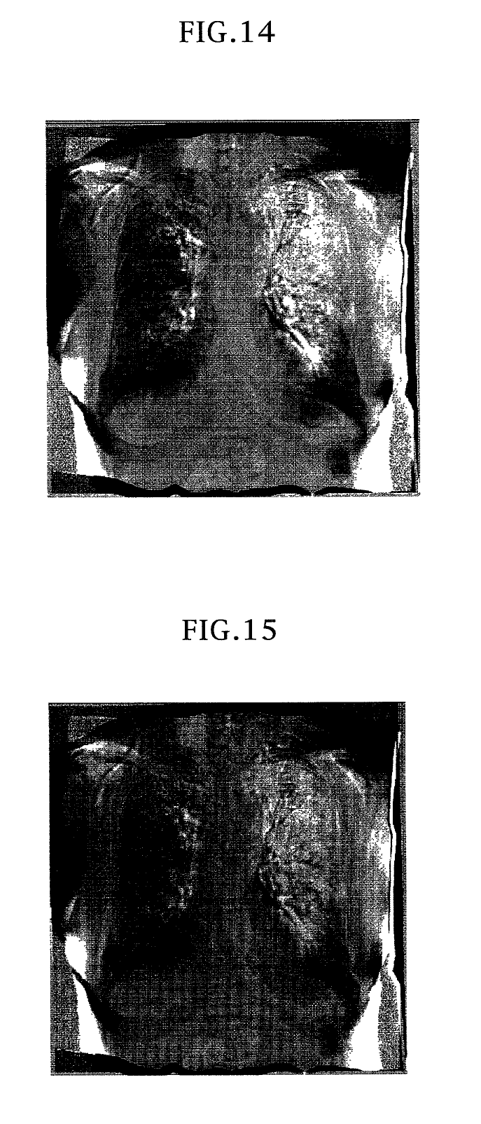

Furthermore, three pairs of FIGS. 10 and 11, FIGS. 12 and 13 and FIGS. 14 and 15 represent other examples to which the present invention is applicable or not applicable, in which FIGS. 11, 13 and 15 represent differential images to which the present invention is not applied, whereas FIGS. 10, 12 and 14 represent differential images to which the present invention is applied. From the comparison of these paired figures, it will be found that, in the differential images to which the present invention is applied, the portions having no shape change appear uniformly.

As mentioned herein above, according to the correction method and apparatus for the differential image detecting the shape change of the present invention, in the differential images detecting the shape changes, the output value at the portion including no shape change can be made always constant. Therefore, even for any input image, similar output images are always obtainable. Furthermore, the outputted differential images can be uniformly observed. That is, the degrees of shape-changes between the outputted differential images can be uniformly observed.

It is to be noted that the present invention is not limited to the described embodiment and many other changes and modifications may be made without departing from the scopes of the appended claims.

What is claimed is

1. A method of correcting a differential image for detecting a shape change between one input image and another input image comprising the steps of:
setting reference areas which are deemed to have no shape change to the one and another input images In1(x,y) and In2(x,y), respectively;
operating average values ave1 and ave2 of pixel values of the reference areas; and
producing a differential image S(x,y) in accordance with an equation of
S(x,y)=In1(x,y)−In2(x,y)−(ave1−ave2).

2. A method of correcting a differential image for detecting shape change according to claim 1, wherein an offset value is applied at the differential image producing step.

3. A method of correcting a differential image for detecting shape change according to claim 1, further comprising a step of displaying the differential image S(x,y).

4. An apparatus for correcting a differential image for detecting shape change comprising:
an image data storing means for storing image data;
a reference area setting means for setting reference areas which are deemed to have no shape change to one and another input images, respectively;
a reading means for reading the image data from the image data storing means and the reference area data from the reference area setting means;
an average value operating means for calculating average values of pixel values of the reference areas of the input images, respectively; and
a differential image producing means for producing a differential image on the basis of the average values calculated in the average value operating means.

5 . An apparatus for correcting a differential image for detecting shape change according to claim 4, further comprising an offset value setting means for applying an offset value to the differential image producing means.

6. An apparatus for correcting a differential image for detecting shape change according to claim 4, further comprising a display means for displaying the differential image.
